(19) United States
(12) Patent Application Publication
(10) Pub. No.: US 2002/0091749 A1
(43) Pub. Date: Jul. 11, 2002

(54) Data transfer efficiency optimizing apparatus for a network terminal and a program product for implementing the optimization

(75) Inventor: Kazuhiro Katayama, Yokohama (JP)

Correspondence Address: McDermott, Will & Emery, 600, 13th Street, N.W., Washington, DC, 20005-3096, US

(73) Assignee: Hitachi, Ltd.

(21) Appl. No.: 09/984,784

(22) Filed: Oct. 31, 2001

(30) Foreign Application Priority Data
Nov. 28, 2000 (JP) 2000-361270

(51) Int. Cl. G06F 15/16

(52) U.S. Cl. 709/201

(57) ABSTRACT

Data is efficiently transferred in a network system while a channel use state and/or a data transfer time is taken into consideration, without increasing the number of hardware communication lines between data processing systems. A data transfer efficiency optimizing apparatus for data processing terminals interconnected by a network, includes a data transfer control unit for setting a plurality of data transfer channels to the network and a data disassembly/assembly unit for disassembling data into data sets corresponding in number to the number of data transfer channels set by the data transfer control unit and for assembling the data sets into the original data. The data transfer control unit sets the plurality of transfer channels so as to obtain a shortest transfer time, according to communication statistical information and a transfer data amount, the communication statistical information including transfer channel running information collected beforehand by the data processing terminal.

### BACKGROUND OF THE INVENTION

The present invention relates to a data transfer efficiency optimizing apparatus for a network terminal, and more particularly to a data transfer efficiency optimizing apparatus capable of improving a data transfer efficiency by multiplexing a data transfer channel and to a program product for implementing a data transfer efficiency optimizing process.

With recent developments of networks, large scale data processing systems interconnected by a network are used. A LAN of a conventional locally concentrated client/server type system is changing to a LAN of a highly open Internet/intranet type system.

In such a network system, there is the tendency that a percentage of interactive transactions by end users, such as information retrieval from a database, is increasing. Such transactions have a high tendency of being concentrated during a particular time zone. It is therefore desired to shorten a response time on the end user side. Several approaches to optimizing the data transfer process are known:

(1) A data transfer time shortening approach by fixedly (statically) multiplexing a data transfer channel.

(2) A data transfer time shortening approach by reducing the amount of transfer data, for example, by data compression.

(3) A data transfer time shortening approach by raising a channel use rate by storing transfer data and transferring data collectively by using FTP (file transfer protocol).

(4) A data transfer amount controlling approach by making a channel use rate constant.

JP-A-8-37533 entitled “Communication Control Apparatus” discloses techniques similar to the approaches (3) and (4). According to the techniques, a system is provided in which the channel use rate is raised by multiplexing (coupling) data when it is transferred to the network and in addition, if it is assumed that congestion may be generated by the data to be transferred, the amount of transfer data is reduced.

### SUMMARY OF THE INVENTION

With the approach (1), however, since data transfer is performed by always using physically multiplexed lines, the data transfer method in the network system is fixed. Therefore, if a certain data transfer channel is being used, there is a possibility that there occurs a wait relative to this data transfer channel. The multiplex degree of a transfer process may be set to 1 or has a limit by the number of physically installed lines. As a result, there is a limit in improving the data transfer efficiency of the whole data processing system.

The approach (2) by data compression is required to perform a data compressing/defreezing process common to systems which perform data transfer, so that this process results in a large overhead.

The approach (3) by FTP collective transfer can raise the channel use rate and improve the data transfer efficiency. However, a response from the destination site is slow, i.e., a response time is long so that applicable transactions are restricted.

The approach (4) by transfer data amount control does not suppress in advance the generation of congestion, but minimizes the influence degree of the network after congestion occurs. The generation of congestion itself cannot be prevented.

The prevent invention has been made in consideration of the above-described problems, and an object of the invention is to provide a data transfer apparatus of a network system capable of efficiently transferring data while a channel use state and/or a data transfer time is taken into consideration, without increasing the number of hardware communication lines between data processing systems.

In order to achieve the above object and according to one solving method, i.e., one aspect of the invention, there is provided a data transfer efficiency optimizing apparatus for data processing terminals interconnected by a network, wherein: each data processing terminal includes a data transfer control unit for setting a plurality of data transfer channels to the network and a data disassembly/assembly unit for disassembling data into data sets corresponding in number to the number of data transfer channels set by the data transfer control unit and for assembling the data sets into the original data; and the data transfer control unit sets the transfer channel number so as to obtain a shortest transfer time, in accordance with communication statistical information and a transfer data amount, the communication statistical information including transfer channel running information collected beforehand by the data processing terminal.

According to this aspect, the data transfer efficiency optimizing apparatus includes a statistical information management unit for acquiring a transfer channel running state and preset system running information as the communication statistical information. The data disassembling/assembling unit disassembles/assembles data in order to multiplexing a transfer channel of transfer data.

Other objects, features and advantages of the present invention will become apparent from the description of the following embodiments of the invention when taken in conjunction with the accompanying drawings.

### BRIEF DESCRIPTION OF THE DRAWINGS

FIG. 1 is a block diagram showing a data transfer efficiency optimizing apparatus for a data processing terminal (network terminal) according to an embodiment of the invention.

FIG. 2 is a schematic diagram showing multiplexed data transfer channels.

FIG. 3 is a table showing examples of communication statistical information stored in a communication statistical information library.

FIGS. 4A, 4B and 4C are diagrams showing examples of system definition information.

FIG. 5 is a table showing examples of connection destination definition information.

FIG. 6 is a diagram showing an example of the format of transfer data.

FIG. 7 is a flow chart illustrating the whole operation of the data transfer efficiency optimizing apparatus.

FIG. 8 is a flow chart illustrating an operation of multiplexing a data transfer channel.

FIG. 9 is a flow chart illustrating a process of calculating a data length capable of obtaining the fastest transfer efficiency.

### DETAILED DESCRIPTION OF THE EMBODIMENTS

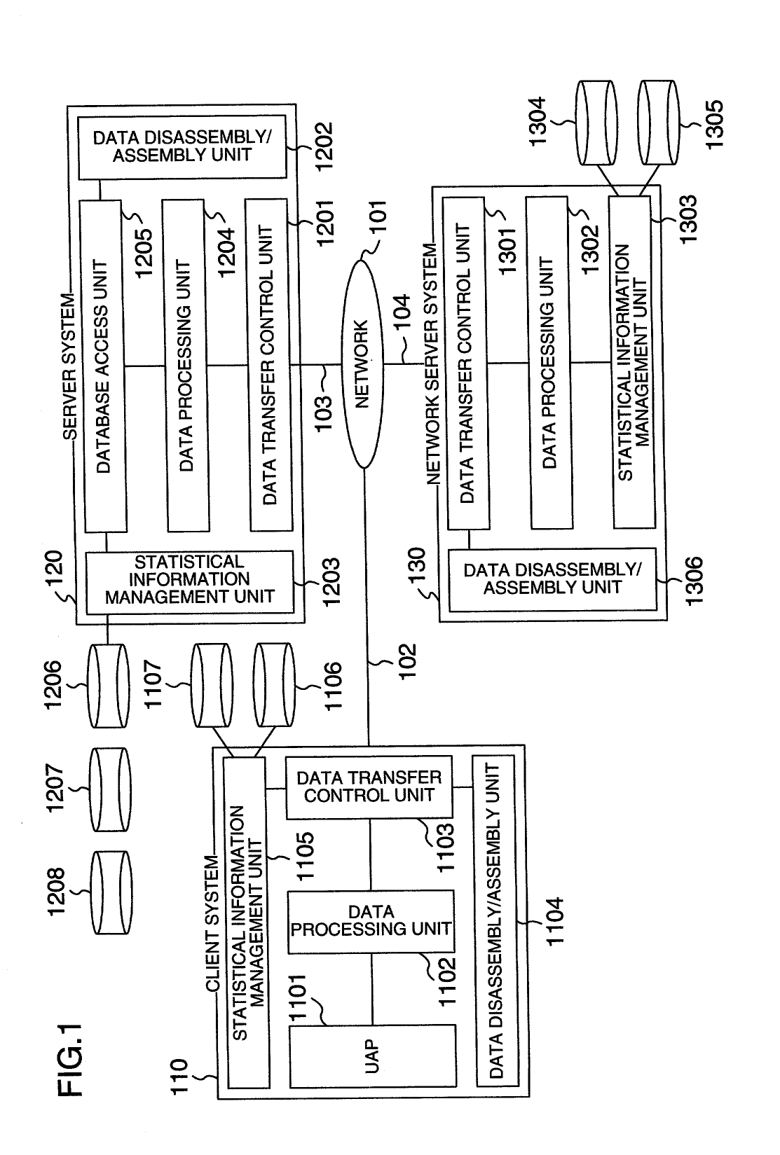

An embodiment of the invention will be described with reference to FIGS. 1 to 9. FIG. 1 is a block diagram showing a data transfer efficiency optimizing apparatus for a data processing terminal according to the embodiment of the invention. In FIG. 1, reference numeral 101 represents a network, and reference numerals 102 to 104 represent communication lines. Transfer channels are constituted of the network 101 and communication lines 102 to 104. Reference numeral 110 represents a client system, reference numeral 120 represents a server system, and reference numeral 130 represents a network server system. The client system 110, server system 120 and network server system 130 are interconnected by the network 101.

In the client system 110, reference numeral 1101 represents a user application program (UAP), reference numeral 1102 represents a data transfer conversion unit (data processing unit) for converting a process request from the user application program into a process request having the format capable of being transferred to the server system, reference numeral 1103 represents a data transfer control unit for transmitting data to a transfer channel, reference numeral 1104 represents a data disassembly/assembly unit for disassembling/assembling data when the data transfer channel is multiplexed, reference numeral 1105 represents a statistical information management unit for acquiring and managing a running state of each transfer channel as communication statistical information, reference numeral 1106 represents a communication statistical information management library for storing communication statistical information managed by the statistical information management unit, and reference numeral 1107 represents a system definition information library for storing system running information which is given beforehand as system setting parameters and the like and which is fixed information given when the system starts running. The statistical information management unit 1105 collects dynamic information changing with time from the library 1106 or a management unit 1304 to be described later.

In the server system 120, reference numeral 1201 represents a data transfer control unit for transmitting/receiving data to/from a transfer channel, reference numeral 1202 represents a data disassembly/assembly unit for disassembling/assembling data when the data transfer channel is multiplexed, reference numeral 1203 represents a statistical information management unit for acquiring and managing a running state of each transfer channel as communication statistical information, reference numeral 1204 represents a data conversion unit for the interface between the data transfer control unit 1201 and a database access unit 1205. The database access unit 1205 accesses a database 1207 managed by the service system 120, reference numeral 1206 represents a communication statistical information management library for storing communication statistical information managed by the statistical information management unit, and reference numeral 1208 represents a system definition information library for storing system running information which is given beforehand as system setting parameters and the like.

The communication statistical information management unit 1105 of the client system 110 and the communication statistical information management unit 1203 of the server system acquire the running state of each transfer channel and stores it in the communication statistical information management libraries 1106 and 1206, respectively, as the communication statistical information.

On the client system 110 side, immediately before data is transmitted to a transfer channel, the statistical information management unit 1105 accesses the communication statistical information management library 1106 to acquire communication statistical information. On the server system 120 side, immediately after data is received from a transfer channel, the statistical information management unit 1203 accesses the communication statistical information management library 1206 to store communication statistical information therein. When data is returned from the server system side 120 to the client system 110 side, the procedure reverse to the above-described procedure is performed.

The data transfer control unit 1201 of the server system 120 calls the data disassembly/assembly unit 1202. The data disassembly/assembly unit 1202 acquires a multiplex key (such as a transfer time and a transfer data length) which is used as criterion information for multiplexing a data transfer channel, by referring to the system definition information library 1208 storing the system running information which is given beforehand as system setting parameters and the like.

If the acquired multiplex key of the transfer channel corresponds to the transfer time, the data transfer control unit 1201 calculates the transfer time from the length of transfer data by referring to the information stored in the communication statistical information library 1206, and divides the data in the unit of a data length capable of retaining an optimum transfer time. If the acquired multiplex key of the transfer channel corresponds to the transfer data length, the data is divided in the unit of this data length.

In the network server system 130, reference numeral 1301 represents a data transfer control unit for transmitting/receiving data to/from a transfer channel, reference numeral 1302 represents a data conversion unit for the interface between the data transfer control unit 1301 and a statistical information management unit 1303, reference numeral 1304 represents a statistical information library for acquiring and managing data transfer information in the whole network system as communication statistical information, reference numeral 1305 represents a system definition information library for storing and managing system running information which is given beforehand as system setting parameters and the like, and reference numeral 1306 represents a data disassembly/assembly unit for disassembling/assembling data when the data transfer channel is multiplexed.

The method of acquiring communication statistical information at the network server system 130 includes a passive acquisition method of storing information transmitted from the client system 110 and server system 120 and a positive acquisition method in which the network server system 130 itself issues an acquisition request to acquire the information. The details of acquiring and managing the running state of the whole network system is disclosed in JP-A-7-282012 entitled “Distributing Running Support Method For A Distributed Data Processing System” and corresponding to U.S. Pat. No. 5,781,743.

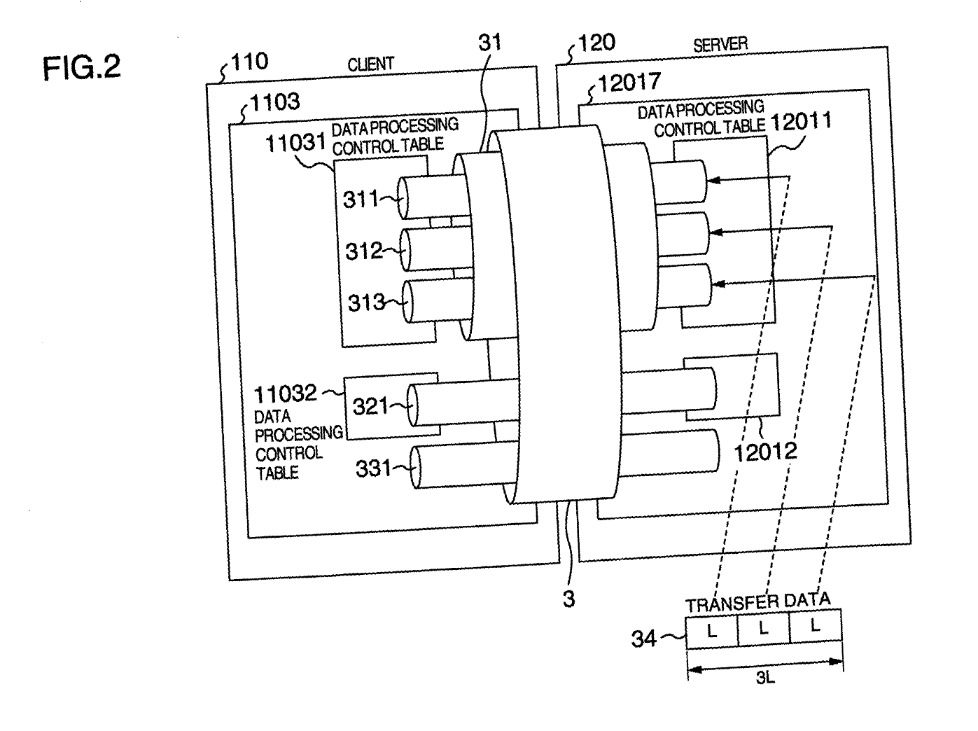

FIG. 2 is a diagram showing an example of multiplexed data transfer channels between the server system 120 and client system 110. In FIG. 2, reference numeral 3 represents a communication line constituting a transfer channel made of a combination of the network 101 and communication lines 102 and 103. Reference numeral 31 represents a virtual data transfer channel formed in the communication line 3, reference numerals 311 to 313 represent virtual data transfer channels formed in the data transfer channel 31, and reference numerals 321 and 331 represent virtual data transfer channels formed in the communication line 3. Reference numerals 11031 and 11032 represent data processing control tables on the client system side, and reference numerals 12011 and 12012 represent data processing control tables on the server system side. Reference numeral 34 represents transfer data to be transferred via a data transfer channel. In FIG. 2 and the following figures, like elements to those shown in FIG. 1 are represented by using identical reference numerals, and the description thereof is omitted.

As shown in FIG. 2, the communication line 3 has the virtual data transfer channel 31 and virtual data transfer channel 321 and 331, and the virtual data transfer channel 31 is further multiplexed. The multiplexed virtual data transfer channels 31 are allocated between the data processing control tables 11031 and 12011. The data transfer channel 321 not multiplexed is allocated between the data processing control tables 11032 and 12012. The data transfer channel 331 is in an empty state.

Before the transfer data 34 (total data length=3L) is transferred by using the virtual data transfer channel 31, the server system 120 determines the optimum data length L by referring to the system definition information library 1208 and communication statistical information library 1206. The total data length (in this example, 3L) is divided by the determined optimum data length and each divided data (data length L) is distributively transferred via the transfer channels 311, 312 and 313.

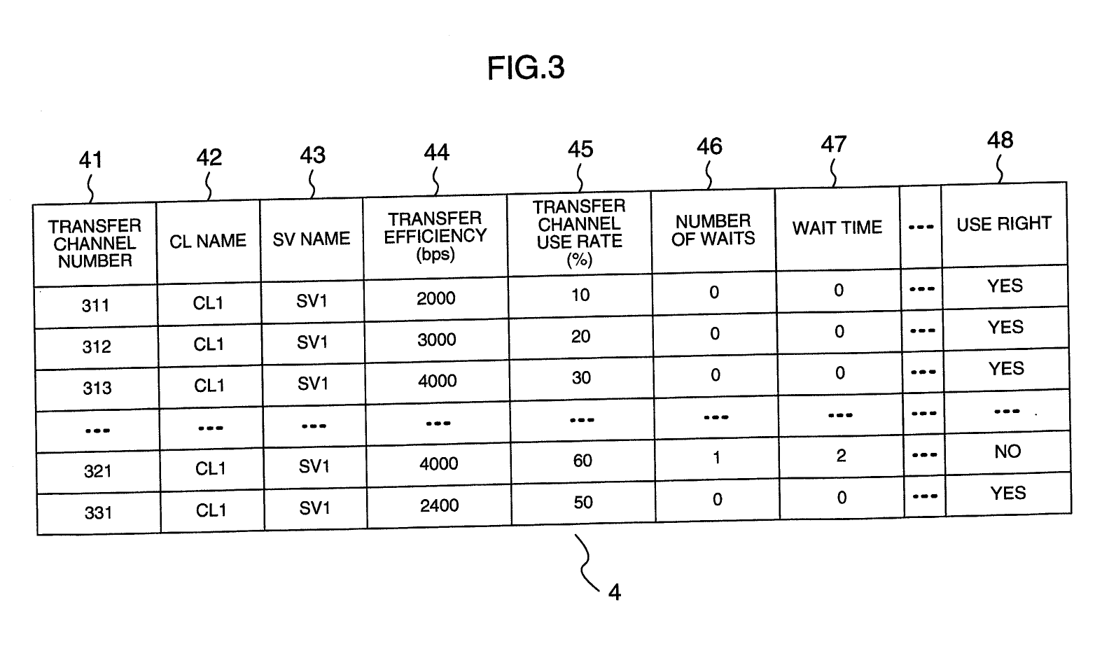

FIG. 3 is a table showing an example of communication statistical information stored in the communication statistical information library 1304 of the network server system 130. In FIG. 3, reference numeral 41 represents a data transfer channel number field, reference numeral 42 represents a client system name field, reference numeral 43 represents a server system name field, reference numeral 44 represents a transfer efficiency (bps) field, reference numeral 45 represents a transfer channel use rate (%) field, reference numeral 46 represents a field for the number of waits, reference numeral 47 represents a wait time field, and reference numeral 48 represents a use right field. As seen from FIG. 3, since the data transfer channels 311, 312 and 313 have the number of waits of “0” and the use right “YES”, it can be understood that these data transfer channels are not presently used and can be used with the highest priority over other data transfer channels. Since the data transfer channel 321 has the number of waits of “1” and no use right “NO”, it can be understood that this transfer channel is presently used and has no use right so that this transfer channel cannot be used.

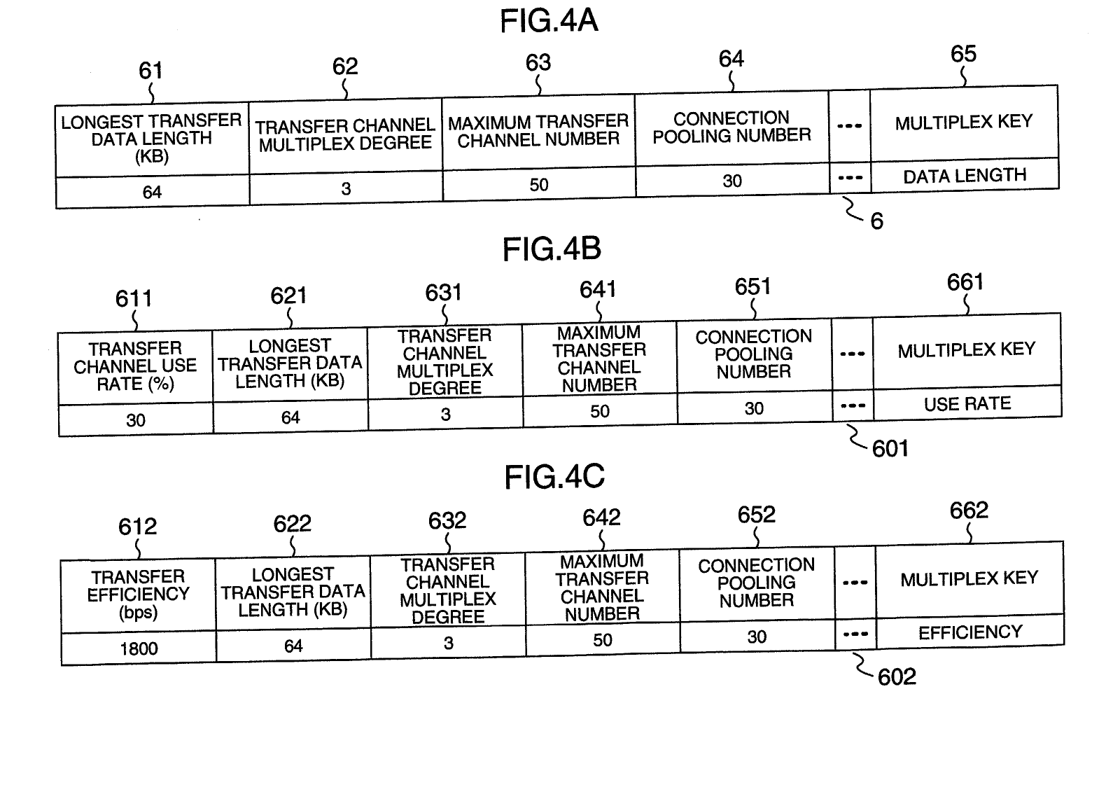

FIGS. 4A to 4C are diagrams showing examples of system definition information. FIG. 4A is a diagram showing an example of system definition information 6 stored in the system definition information libraries 1107, 1208 and 1305 of the client system 110, server system 120 and network server system 130, respectively. This system definition information library has various fields including a longest transfer data length field 61, a data transfer channel multiplex degree field 62, a maximum data transfer channel number field 63, a connection pooling number field 64 and a multiplex key field 65. In the example shown in FIG. 4A, it is defined that since the multiplex key is a data length, the transfer data is divided in the unit of 64 KB and transferred by using three data transfer channels.

FIG. 4B is a diagram showing another example of system definition information 601. This system definition information library has various fields including a transfer channel use rate field 611, a longest transfer data length field 621, a data transfer channel multiplex degree field 631, a maximum data transfer channel number field 641, a connection pooling number field 651 and a multiplex key field 661. In the example shown in FIG. 4B, it is defined that since the multiplex key is a transfer channel use rate, the data transfer is performed at a transfer channel use rate of 30% by using three data transfer channels.

FIG. 4C is a diagram showing another example of system definition information 602. This system definition information library has various fields including a transfer efficiency (bps) field 612, a longest transfer data length field 622, a data transfer channel multiplex degree field 632, a maximum data transfer channel number field 642, a connection pooling number field 652 and a multiplex key field 662. In the example shown in FIG. 4C, it is defined that since the multiplex key is a transfer efficiency, the data transfer is performed at a transfer efficiency of 1800 bps by using three data transfer channels.

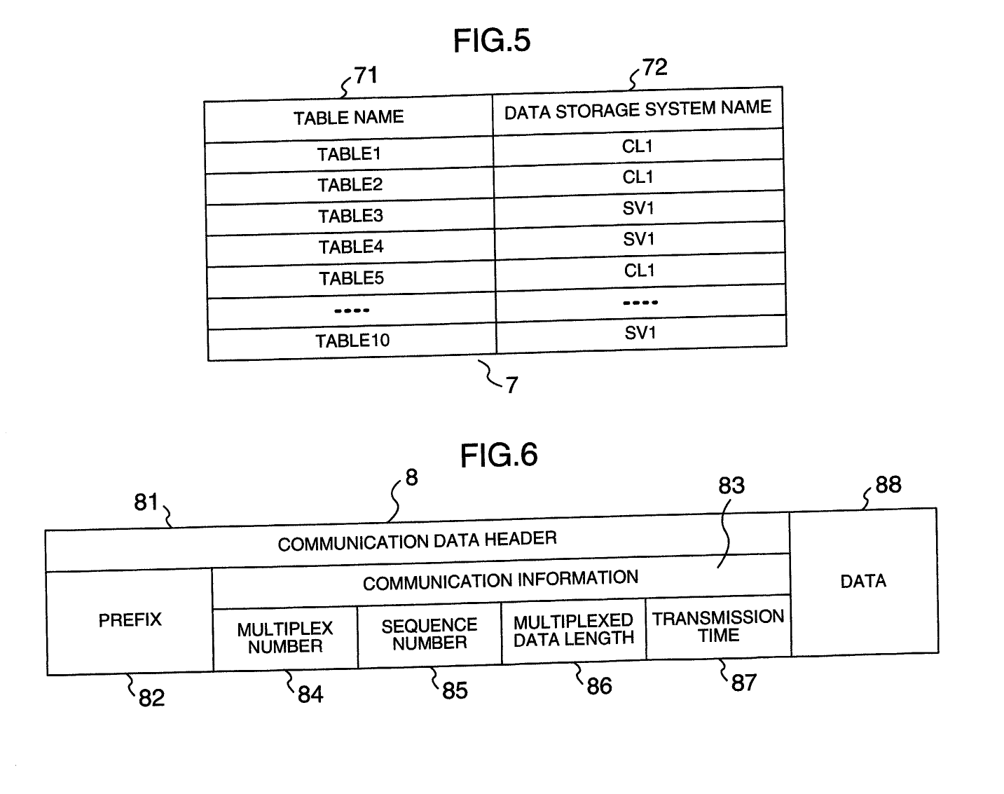

FIG. 5 is a diagram showing an example of connection destination definition information stored in the system definition information libraries 1107, 1208 and 1305 of the client system 110, server system 120 and network server system 130, respectively. Reference numeral 7 represents connection destination definition information, reference numeral 71 represents a table name, and reference numeral 72 represents the name of a storage destination system in which a real table corresponding to the table name 71 is stored. For example, it can be seen that the name of a storage destination system in which the real table corresponding to the table name TABLE3 is SV1.

FIG. 6 is a diagram showing an example of the format of transfer data. In FIG. 6, the transfer data format 8 includes a transfer data header field 81, a prefix field 82, a communication information field 83, a multiplex degree field 84 for indicating the number of divisions of transfer data, a data assembly sequence number field 85, a multiplexed data length field 86 for indicating the length of divided transfer data, and a transmission time field 87 for indicating the time when transfer data is transmitted. This format is used when transfer data is transferred between, for example, the client system 110 and server system 120.

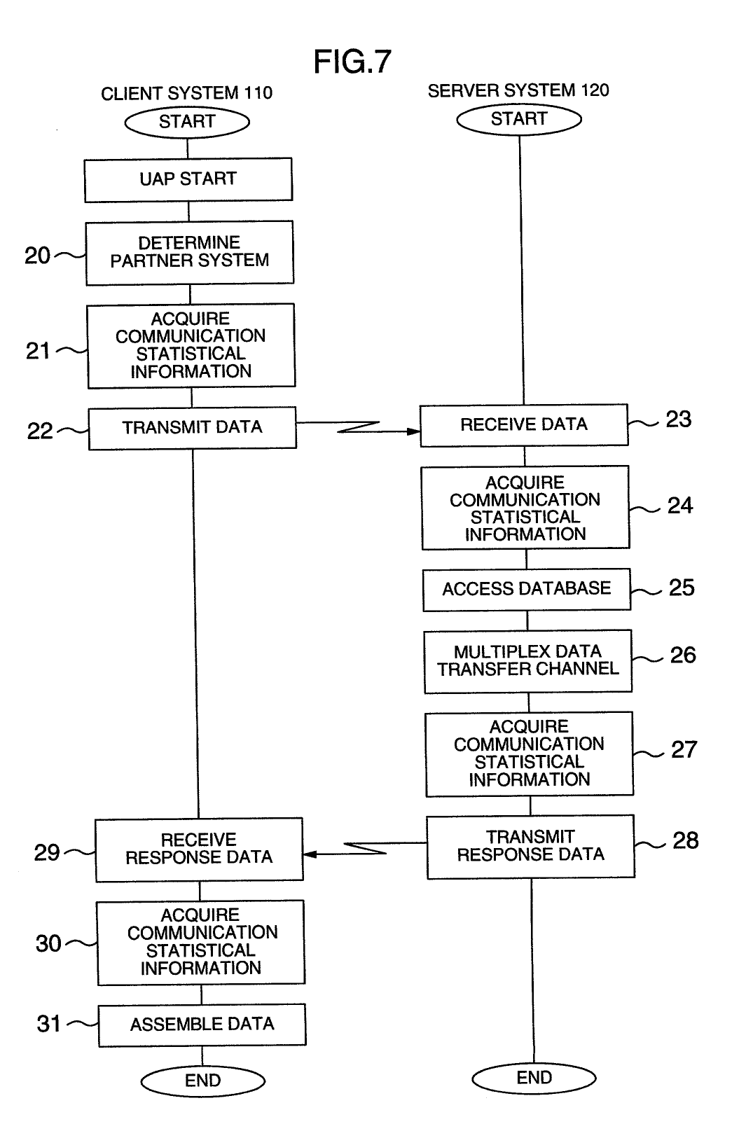

Next, the operation of the embodiment will be described with reference to flow charts shown in FIGS. 7 to 9. FIG. 7 is a flow chart illustrating the whole operation of the data transfer efficiency optimizing apparatus. First, in the client system 110, when the user application program 1101 of the system issues a data transfer request, at Step 20 the connection destination information table 7 shown in FIG. 5 and stored in the system definition information library 1107 is referred to determine the data storage server system name 72 from the table name 71 to be accessed (e.g., if the table name to be accessed is TABLE3, the server system name is SV1). At Step 21 the data processing unit 1102 generates transfer data, and thereafter the data transfer control unit 1103 is called. The data transfer control unit 1103 calls the statistical information management unit 1105 to acquire communication statistical information from the communication statistical information management library 1106. At Step 22 the control is passed to the data transfer control unit 1103 to transmit the data to the communication line.

On the server system side 120, at Step 23 the data from the communication line is received at the data transfer control unit 1201. At Step 24 the statistical information management unit 1203 is called to store the communication statistical information acquired at the time when the data was received, in the communication information management library 1206. At Step 25, the control is returned to the data transfer control unit 1201. The data transfer control unit 1201 calls the data processing unit 1204 and database access unit 1205 to access the database 1207. At Step 26, the control is returned back to the data transfer control unit 1201 via the database access unit 1205 and data processing unit 1204. The data transfer control unit 1201 generates return data to return the database access result to the client system 110. Next, the data disassembly/assembly unit 1202 is called whereat the return data is divided in accordance with the multiplex number of the data transfer channel to be described later, and then the control is passed to the data transfer control unit 1201. At this time, data transfer channels corresponding in number to multiplexed data sets to be transferred are established between the server system 120 and client system 110. The format of data to be transmitted over each transfer channel is as shown in FIG. 6. At Step 27 the data transfer control unit 1201 calls the statistical information management unit 1203 to acquire communication statistical information at the time when the data is transferred, from the statistical information management library 1206. At Step 28 the control is returned back to the data transfer control unit 1201 which transfers the return data divided for each data transfer channel to the communication line and to the client system.

On the client system 110 side, at Step 29 the return data from the communication line is received at the data transfer control unit 1103. At Step 30 the statistical information management unit 1105 is called to store the communication statistical information acquired at the time when the data is received, in the communication statistical information management library 1106. At Step 31, the control is returned back to the data transfer control unit 1103 to call the data disassembly/assembly unit 1104. The data disassembly/assembly unit 1104 assembles the data divided and transferred via three data transfer channels 311, 312 and 313 into one set of the return data. More specifically, the data disassembly/assembly unit 1104 reads the multiplex degree 84 (in this example, 3) and division data length 86 (in this example, 64 KB) stored in the header field of the received data shown in FIG. 6, and reserves a work memory area (64 KB×3) in which divided data is assembled into one data set. Each time the data is received from the server system 120, the data disassembly/assembly unit 1104 stores the data in a corresponding work memory area by using the data sequence number 85 as a key. Namely, the data assembly process by the data disassembly/assembly unit 1104 and the data reception process by the data transfer control unit 1103 are executed in parallel. When all the data storage is completed, the control is passed to the data processing unit 1102. The data processing unit 1102 converts the format of the return data into a format suitable for the user application program, and transfers the converted data to the user application program 101 as the database access result.

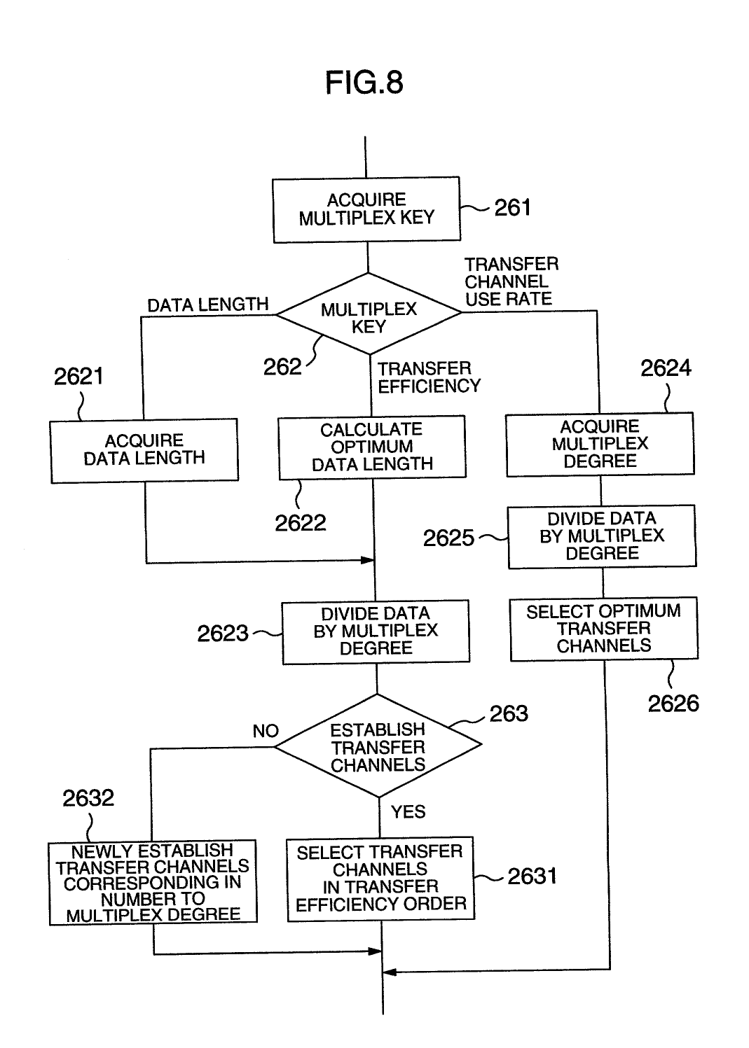

FIG. 8 is a flow chart illustrating a process of multiplexing a data transfer channel at Step 26 shown in FIG. 7. This process of multiplexing a data transfer channel is executed when data is transferred between the client system 110 and server system 120. The data transfer channel is determined in accordance with the type of an acquired multiplex key 261. When multiplex data is generated on the server system side, first at Step 261 a multiplex key is acquired by referring to the information 6 on the data transfer channel shown in FIG. 4A and stored in the system definition information library 1208. At Step 262 the type of the acquired multiplex key is judged. Namely, it is judged whether the acquired key corresponds to a data length, a transfer channel use rate, or a transfer efficiency. If the multiplex key corresponds to the data length 65, the flow branches to Step 2621, if the multiplex key corresponds to the transfer channel use rate, the flow branches to Step 2624, and if the multiplex key corresponds to the transfer efficiency, the flow branches to Step 2622. It is herein assumed that the acquired multiplex key corresponds to the data length 65. In this case, the flow branches to Step 2621 whereat the division data length 61 (64 KB) is acquired from the information 6 on the data transfer channel stored in the system definition information library 1208. At Step 2623, the transfer data 34 is divided by the data length 61 (64 KB) to obtain the multiplex degree of the data transfer channel 31. If the total data is 3×64 KB, the transfer data 34 is divided in the unit of 64 KB and the multiplex degree is set to “3”. At Step 263 it is checked whether the transfer channels corresponding to the multiplex degree have been established. If established, the flow advances to Step 2631 whereat usable data transfer channels, e.g., channels 311, 312 and 313 are selected in the transfer efficiency order in accordance with the data communication line running information 4 stored in the statistical information management library 1206. If the transfer channels are not established, the flow branches to Step 2632 whereat data transfer channels corresponding in number to the multiplex degree are newly established.

If the acquired key corresponds to the transfer channel use rate at Step 262, the flow branches to Step 2624. At Step 2624 the use rate 611 is acquired from the information 601 on the data transfer channel shown in FIG. 4B and stored in the system definition information library 1208. The data transfer channels 311, 312 and 313 satisfying the use rate 611 are selected from the communication statistical information 4 shown in FIG. 3 and stored in the statistical information management library 1206. At Step 2625 the transfer data 34 is divided by the number of selected data transfer channels, and at Step 2626 the optimum transfer channels are selected.

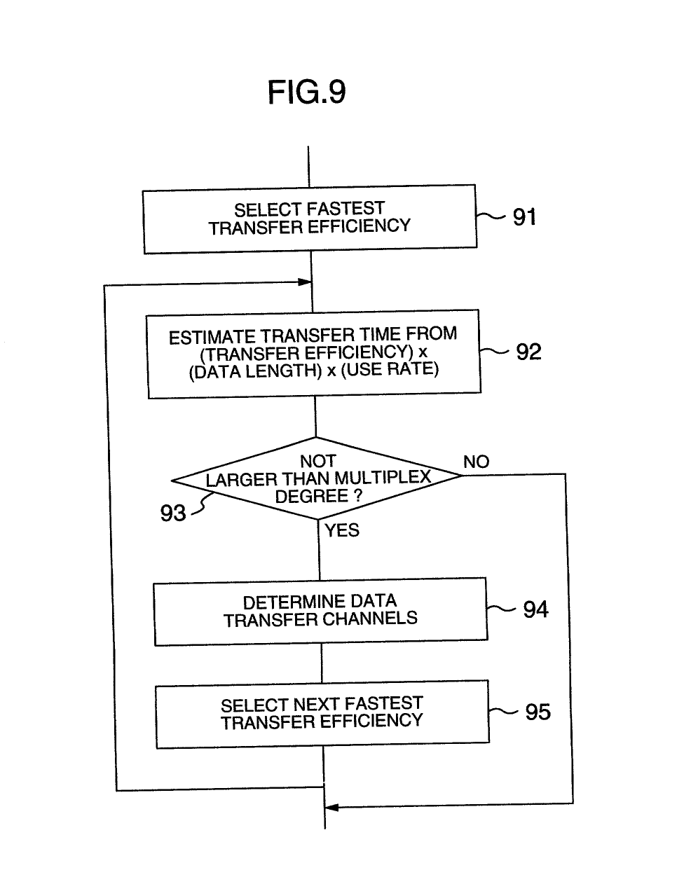

If the acquired key corresponds to the transfer efficiency at Step 262, the flow branches to Step 2622. At Step 2622 the transfer efficiency 612 is acquired from the information 602 on the data transfer channel shown in FIG. 4C and stored in the system definition information library 1208, and the optimum data length of the data transfer channel is calculated by using the communication statistical information 4 shown in FIG. 3 and stored in the statistical information management library 1206, in accordance with the flow chart shown in FIG. 9 to be described later. Next, the transfer data 34 is divided by the data length 61 to obtain the multiplex degree of the data transfer channel 31 to thereafter advance to Step 2623.

FIG. 9 is a flow chart illustrating the process of calculating the data length capable of obtaining the fastest transfer efficiency of data transfer between the client system 110 and server system 120, the process corresponding to Step 2622 shown in FIG. 8. First, at Step 91 the transfer efficiency 612 acquired from the information 602 on the data transfer channel stored in the system definition information library 1208 is used as the fastest transfer efficiency. At Step 92 the transfer time is estimated by (transfer efficiency)×(data length)×(use rate). At Step 93 the transfer data 34 shown in FIG. 2 is divided by the longest transfer data length 622 shown in FIG. 4C to obtain the multiplex degree of the data transfer channel 31. At Step 94 the obtained multiplex degree is compared with the transfer channel multiplex degree 632 shown in FIG. 4C acquired from the information 602 on the data transfer channel stored in the system definition information library 1208. If the obtained multiplex degree is equal to or smaller than the transfer channel multiplex degree 632, the flow advances to Step 94. At Step 94, usable data transfer channels, e.g., channels 311, 312 and 313 are selected in accordance with the communication statistical information 4 stored in the statistical information management library 1206. At Step 95 the data length capable of obtaining the next fastest transfer efficiency is calculated for the selection at Step 2631.

As described above, according to the embodiment, upon occurrence of a data transfer request for transferring data from one data processing system to another data processing system, the data processing apparatus issued the data transfer request acquires communication statistical information on the data transfer time from the communication statistical information management library. Namely, the communication statistical information is acquired dynamically at the time when the data transfer request is issued. In accordance with the communication statistical information, the multiplex degree of a data communication channel is determined from the transfer data amount in such a manner that the data transfer time becomes shortest, and the data is transferred. Accordingly, the data transfer efficiency of the whole system can be improved.

As described so far, according to the invention, it is possible to efficiently transfer data in a network system while a channel use state and/or a data transfer time is taken into consideration, without increasing the number of hardware communication lines between data processing systems.

What is claimed is:

1. An apparatus for optimizing a data transfer efficiency for data processing terminals interconnected by a network,
each data processing terminal comprising a data transfer control unit for setting a plurality of data transfer channels to the network and a data disassembly/assembly unit for disassembling data into data sets corresponding in number to the number of data transfer channels set by said data transfer control unit and for assembling the data sets into the original data; and
said data transfer control unit setting the transfer channel number so as to obtain a shortest transfer time, in accordance with communication statistical information and an amount of data to be transferred said communication statistical information including transfer channel running information collected beforehand by the data processing terminal.

2. A data transfer efficiency optimizing apparatus according to claim 1, wherein said communication statistical information includes a time, a transfer data length, a transfer time, a partner system name, and a transfer efficiency.

3. A data transfer efficiency optimizing apparatus according to claim 1, wherein the plurality of data transfer channels are virtual data transfer channels established by the data transfer control unit in the network.

4. A data transfer efficiency optimizing apparatus according to claim 1, wherein if the transfer channel number is unable to be set, a default value is selected.

5. A program product including a computer readable storage medium storing a program for making a computer perform a data transfer efficiency optimizing operation for each of data processing terminals interconnected by a network,
said program causing the computer to perform a data transfer control function for setting a plurality of data transfer channels to the network and a data disassembly/assembly function for disassembling data into data sets corresponding in number to the number of data transfer channels set by the data transfer control unit and for assembling the data sets into the original data; and
said data transfer control function setting the plurality of transfer channels so as to obtain a shortest transfer time, in accordance with communication statistical information and a transfer data amount, the communication statistical information including transfer channel running information collected beforehand by the data processing terminal.

6. A method of optimizing a data transfer efficiency of data terminals interconnected by a network, comprising steps of, at each transfer originating data terminal:
virtually setting a plurality of data transfer channels for a partner data terminal to the network;
disassembling data into data sets corresponding in number to the number of data transfer channels virtually set and assembling the data sets into the original data;
collecting and storing beforehand transfer channel running information; and
determining the transfer channel number so as to obtain a shortest transfer time, in accordance with communication statistical information and a transfer data amount, the communication statistical information including transfer channel running information collected and stored beforehand by the transfer originating data processing terminal.

7. A method according to claim 6, wherein the communication statistical information includes a time, a transfer data length, a transfer time, a partner system name, and a transfer efficiency.

8. A method according to claim 6, wherein if said transfer channel number determining step cannot determine the transfer channel number, a default value is selected.

9. A method according to claim 6, wherein a terminal as a network server system manages the communication statistical information of the whole network, and said determining step uses the communication statistical information supplied from the network server system.

10. A method according to claim 6, wherein each data terminal acquires the communication statistical information from a system specification information management library for collectively managing system specification information of each data terminal.

11. A computer-implemented program for performing, by using a computer, the operation of optimizing a data transfer efficiency of data terminals interconnected by a network, comprising steps of, at each transfer originating data terminal:
virtually setting a plurality of data transfer channels for a partner data terminal to the network;
disassembling data into data sets corresponding in number to the number of data transfer channels virtually set and assembling the data sets into the original data;
collecting and storing beforehand transfer channel running information; and
determining the transfer channel number so as to obtain a shortest transfer time, in accordance with communication statistical information and a transfer data amount, the communication statistical information including transfer channel running information collected and stored beforehand by the transfer originating data processing terminal.
